(19) United States
(12) Patent Application Publication
(10) Pub. No.: US 2025/0262860 A1
(43) Pub. Date: Aug. 21, 2025

(54) DROP-ON-DEMAND PRINT HEAD MAINTENANCE IN A CARD PERSONALIZATION SYSTEM

(71) Applicant: Entrust Corporation, Shakopee, MN (US)

(72) Inventor: Kevin BONTRAGER, Shakopee, MN (US)

(21) Appl. No.: 19/045,737

(22) Filed: Feb. 5, 2025

Related U.S. Application Data
(60) Provisional application No. 63/555,200, filed on Feb. 19, 2024.

(51) Int. Cl. B41J 2/165; B41J 2/14; B41J 2/21; B41J 11/00; B41M 3/00; B41M 3/14

(52) U.S. Cl. CPC B41J 2/16526; B41J 2/1433; B41J 2/2103; B41J 2/2117; B41J 11/0021; B41M 3/005; B41M 3/14

(57) ABSTRACT

A card (or passport) personalization system is described that includes a print mechanism with one or more DOD print heads. A maintenance routine, also referred to as a spitting routine, is described where one or more nozzles of the DOD print head is electrically actuated a plurality of times in rapid succession, each actuation emitting a small drop of ink. The small drops of ink join together in flight after being ejected to create one or more larger waste ink drops. The larger ink drop(s) has less tendency to aerosolize which reduces aerosol contamination of the nozzle plate and the nozzle.

### PRIORITY

This application claims the benefit of priority to U.S. Provisional application No. 63/555,200 filed on Feb. 19, 2024, the entire contents of which are incorporated herein by reference.

### FIELD

This technical disclosure relates to maintaining drop-on-demand (DOD) print heads used in card (or passport) personalization systems.

### BACKGROUND

In DOD printing, ink is ejected from one or more nozzles of a print head by electrically energizing select ones of the nozzles from which the ink is to be ejected. If a nozzle is not used periodically, the nozzle can become completely or partially clogged with ink or other debris preventing its operation or causing the nozzle to eject ink incorrectly. U.S. Pat. No. 11,072,169 describes an example of a card personalization system that employs automated maintenance routines on a DOD print head to prevent clogging of the DOD print head. U.S. Pat. No. 11,072,169 is incorporated herein by reference in its entirety.

In a card personalization system that employs DOD printing, the card throughput (i.e. the number of cards printed per unit of time) is an important factor and an effort is made to minimize the downtime of the card personalization system for maintenance in order to maximize the card throughput. In addition, in a card personalization system that employs DOD printing, the printing that is performed on the cards, and therefore the nozzles that are energized, could vary from card to card within a batch print job or could vary from one batch print job to another batch print job.

A conventional maintenance routine that occurs on a DOD print head is referred to as spitting where one or more nozzles of the DOD print head are energized to eject a small drop of waste ink. In a conventional spitting routine that occurs on some types of DOD print heads, the size of the ejected drop of waste ink is such that the drop has a tendency to aerosolize. The aerosol may float back up to the nozzle plate of the DOD print head and land on the nozzle plate requiring cleaning of the nozzle plate and/or travel back into the nozzle which can cause blockage of the nozzle.

### SUMMARY

A card (or passport) personalization system is described that includes a print mechanism with one or more DOD print heads. Automated maintenance routines are described herein that can be implemented to help maintain the operability of the one or more DOD print heads. The maintenance routines described herein are automated and can be used individually, collectively, or in any combination thereof to help maintain the operability of the one or more DOD print heads in the card personalization system. The card personalization system described herein can be any card personalization system that can process cards by printing on the cards using the one or more DOD print heads, for example piezo-electric print heads, optionally in combination with one or more of: reading data from and/or writing data to a magnetic strip on the card; programming an integrated circuit chip on the card; emboss characters on the card; indenting characters on the card; laminating the card; using a laser that performs laser processing such as laser marking on the card; applying a topcoat to a portion of or the entire surface of the card; checking the quality of personalization/processing applied to the card; applying a security feature such as a holographic foil patch to the card; and other processing operations.

The DOD print heads can be piezo-electric print heads. The print mechanism can perform monochromatic or multi-color printing. In one example of multi-color printing, five DOD print heads, each of which has a plurality of nozzles, can be provided. Each print head can be designated to print a specific color ink, such as cyan, magenta, yellow, black and white (CMYKW). There may also be a DOD print head that prints a varnish. The print mechanism can print using any suitable ink used in DOD printing and that is suitable for use on the types of cards described herein. For example, the ink and/or varnish can be a radiation, such as ultraviolet (UV) radiation, curable ink.

In addition, the card personalization system sequentially prints on individual cards one after the other. The printing on each individual card will be referred to herein as an individual card print job or similar. In addition, a plurality of the cards can be printed in one continuous production run which will be referred to herein as a batch card print job or similar. In some embodiments, the printing that is performed during each individual card print job can, and often does, vary from card to card. For example, each card can be printed with the name and/or the account number of the respective intended cardholder. Since the intended cardholder of each card is different and each card has a unique account number, the printing that is performed on each card differs. In some embodiments, within a single batch print job, the printing on each card could be the same. Alternatively, in other embodiments, the printing on some or all of the cards in a single batch print job could be different.

The differences in printing from card to card, or from batch print job to batch print job, means that some of the nozzles of the DOD print head may not be used frequently or at all for a time period, yet those nozzles must be maintained ready for use for the next card or for the next batch print job without shutting down the card personalization system (or shutting down the print mechanism) as a shut-down for maintenance would reduce the card throughput.

One maintenance routine described herein may be referred to as a spitting routine. In a conventional spitting routine, data associated with firing of a nozzle to eject a drop of ink is sent to the print head between each firing of the nozzle, with each data signal causing a single firing of the nozzle. For example, in the conventional spitting routine, there was an interval of about 0.1 milliseconds (100 microseconds) between each single firing. That is, single, small waste ink drops were ejected at a frequency of 10 KHz.

In contrast, in the spitting routine described herein, the data set to perform the multiple firings of the nozzle is sent to the print head in a single nozzle actuation data signal. In other words, a single nozzle actuation data signal with multiple firing commands can be sent in the spitting routine described herein, as opposed to separate nozzle actuation data signals each with a single firing command in the conventional spitting routine. The single nozzle actuation data signal with multiple firing commands causes the nozzle to be electrically actuated a plurality of times in rapid succession, each actuation emitting a small drop of ink. Each nozzle is actuated as fast as is sustainably possible. Having the actuations as close as possible in time allows the individual waste ink drops to join together into one or more larger waste ink drops. The larger ink drop(s) has a size that exceeds a waste ink drop size that would result from a single electrical actuation of the nozzle. The larger ink drop(s) has less tendency to aerosolize which reduces aerosol contamination of the nozzle plate and the nozzle.

The spitting routine described herein also reduces the amount of nozzle purging that occurs, which reduces the amount of waste ink that is created. Purging refers to a maintenance process where the nozzle is not electrically energized but the vacuum pressure holding the ink in the nozzle is reversed to push ink out of the nozzle using a positive pressure. Purging typically creates a larger amount of waste ink compared to spitting. By implementing the spitting routine described herein, a frequency of purging that is implemented can be reduced compared to a nozzle that is maintained using the conventional spitting routine.

In one example, a method of maintaining a first drop-on-demand print head in a print mechanism of a card or passport personalization system can include printing on a first card or passport in the print mechanism using the first drop-on-demand print head. Sometime after the printing on the first card or passport, a maintenance routine can be conducted on the first drop-on-demand print head. The maintenance routine includes sending a nozzle actuation data signal to the drop-on-demand print head, where the nozzle actuation data signal includes two or more nozzle firing commands each of which electrically actuates one or more nozzles of the first drop-on-demand print head. In addition, after the maintenance routine, a second card or passport is printed on in the print mechanism using the first drop-on-demand print head.

In another example, a method of maintaining a drop-on-demand print head in a print mechanism of a card or passport personalization system includes printing on a first card or passport in the print mechanism using the drop-on-demand print head. Sometime after the printing on the first card or passport takes place, a maintenance routine is conducted on the drop-on-demand print head. The maintenance routine (which may also be referred to as a spitting routine) includes electrically actuating one or more nozzles of the drop-on-demand print head at least two times in succession triggering at least two ejections of waste ink that join in flight to create one or more larger waste ink drops. The larger waste ink drop(s) has a size that exceeds a waste ink drop size that would result from a single electrical actuation of the one or more nozzles of the drop-on-demand print head. Sometime after the maintenance routine is performed, a second card or passport is printed on in the print mechanism using the drop-on-demand print head.

In another example, a method of maintaining a drop-on-demand print head in a print mechanism of a card or passport personalization system includes printing on a first card or passport in the print mechanism using the drop-on-demand print head which includes a plurality of nozzles. After printing on the first card or passport, a maintenance routine (which may also be referred to as a spitting routine) is conducted on the drop-on-demand print head. The maintenance routine includes electrically actuating a first set of the nozzles to trigger an ejection of waste ink from each electrically actuated nozzle of the first set. During the maintenance routine, a second set of the nozzles is not electrically actuated and do not eject waste ink. In one embodiment, the first set of nozzles may be electrically actuated a plurality of times in rapid succession to create one or more larger waste ink drops. In another embodiment, the first set of nozzles may be electrically actuated a single time like in a conventional spitting routine. Sometime after the maintenance routine is performed, a second card or passport is printed on in the print mechanism using the drop-on-demand print head.

In one version of a card or passport personalization system described herein, the system can include an input that is configured to hold a plurality of cards or passports to be processed; a print mechanism downstream from the input and receiving cards or passports that are input from the input, the print mechanism includes a first drop-on-demand print head, and the first drop-on-demand print head is configured to print with ink; and a controller connected to the print mechanism and that automatically controls the operation thereof. The controller is programmed to control printing on the cards or passports and to automatically perform a maintenance routine on the first drop-on-demand print head that includes generating a nozzle actuation data signal, where the nozzle actuation data signal includes two or more nozzle firing commands each of which is able to electrically actuate one or more nozzles of the first drop-on-demand print head.

Another version of a card or passport personalization system described herein can include an input that is configured to hold a plurality of cards or passports to be processed. A print mechanism is provided downstream from the input and receives cards or passports that are input from the input. The print mechanism includes a drop-on-demand print head that is configured to print with ink. A controller is connected to the print mechanism that automatically controls the operation thereof. The controller is programmed to control printing on the cards or passports and to automatically perform a maintenance routine on the drop-on-demand print head that includes electrically actuating one or more nozzles of the drop-on-demand print head at least two times in succession triggering at least two ejections of waste ink that join in flight to create one or more larger waste ink drops each having a size that exceeds a waste ink drop size that would result from a single electrical actuation of the one or more nozzles of the drop-on-demand print head.

### DRAWINGS

FIG. 1 is a close-up view of a pair of nozzles of a DOD print head in a print mechanism of a card personalization system showing a maintenance routine described herein.

FIG. 2 illustrates a method of maintaining the DOD print head.

FIG. 3 illustrates select components of the print mechanism including the DOD print head.

FIG. 4 is an end view of the nozzle plates of a pair of the DOD print heads.

FIG. 5 schematically illustrates an example of a card personalization system that can utilize the DOD print head described herein.

### DETAILED DESCRIPTION

As used herein, the word “step” should be construed, unless otherwise indicated by Applicant, as including a single step or multiple sub-steps resulting in the step.

The following is a description of automated maintenance routines that occur on one or more DOD print heads in a print mechanism of a card (or passport) personalization system to help maintain the operability of the DOD print head(s). For convenience, this description will describe the system as a card personalization system. However, the concepts described herein can also be used in systems that personalize passports (passport personalization systems). The term “personalize” (or the like) as used throughout the specification and claims, unless indicated otherwise, is intended to encompass operations performed on a card (or a page of a passport) that includes operations that result in personalizing the card as well as operations that do not result in personalizing the card. An example of a personalization operation that personalizes the card is printing the cardholder's image or name (using alphanumeric characters) on the card. An example of a personalization operation that does not personalize the card is printing non-card holder graphics on the card. The term “personalize” is often used in the personalized card industry to refer to cards that undergo both personalization processing operations and non-personalization processing operations.

In an embodiment, the cards that are printed may be plastic cards or non-plastic cards. The cards (or personalized identification cards) described herein include, but are not limited to, financial (e.g., credit, debit, or the like) cards, access cards, driver's licenses, national identification cards, and business identification cards, and other identification cards. In an embodiment, the cards may be ID-1 cards as defined by ISO/IEC 7810. However, other card formats such as ID-2 as defined by ISO/IEC 7810 are possible as well. The printing can also occur on pages, such as plastic pages, of passports as well. The passport pages can be a front cover or a rear cover of the passport, or an internal page (for example a page referred to as a data page) of the passport. In an embodiment, the passports may be in an ID-3 format as defined by ISO/IEC 7810.

The term “card” or “identification card”, unless indicated otherwise, refers to cards where the card substrate can be formed entirely of a material such as plastic, or formed of a combination of materials such as plastic and non-plastic materials. In one embodiment, the card can be sized to comply with ISO/IEC 7810 with dimensions of about 85.60 by about 53.98 millimeters (about 3⅜ in×about 2⅛ in) and rounded corners with a radius of about 2.88-3.48 mm (about ⅛ in). As would be understood by a person of ordinary skill in the art of identification cards, the cards are typically formed of multiple individual layers that form the majority of the card body or the card substrate. Similarly, the term “page” of a passport refers to passport pages where the passport can be formed entirely of a material such as plastic, or formed of a combination of materials such as plastic and non-plastic materials. An example of a passport page is the data page in a passport containing the personal data of the intended passport holder. The passport page may be a single layer or composed of multiple layers. In the case of a plastic card, examples of plastic materials that the card (or passport page), or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN®, combinations thereof, and other plastics.

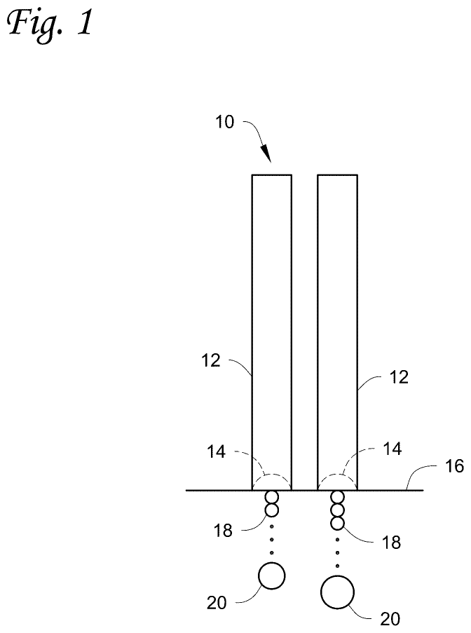

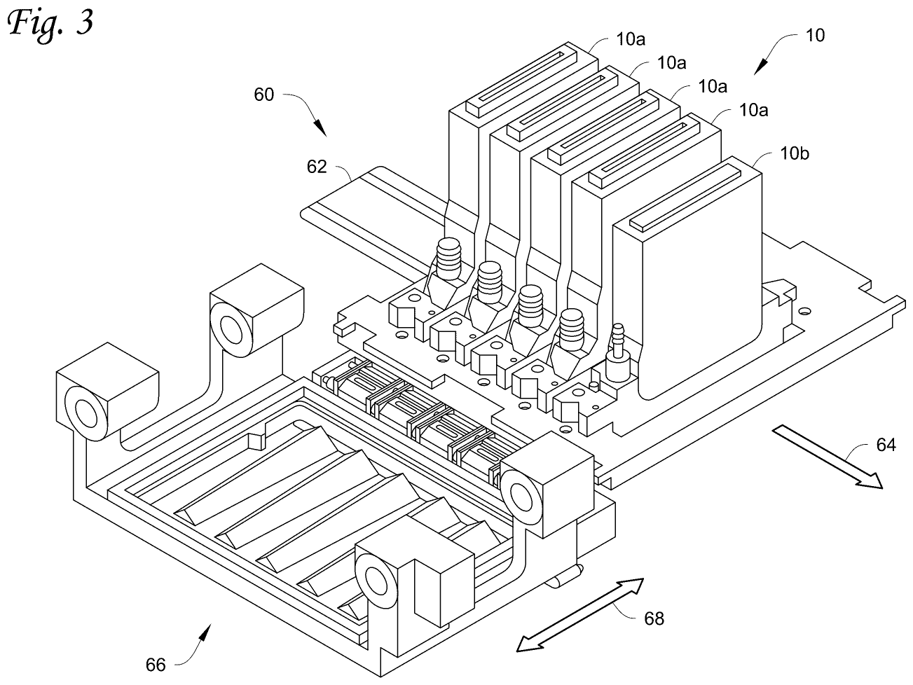

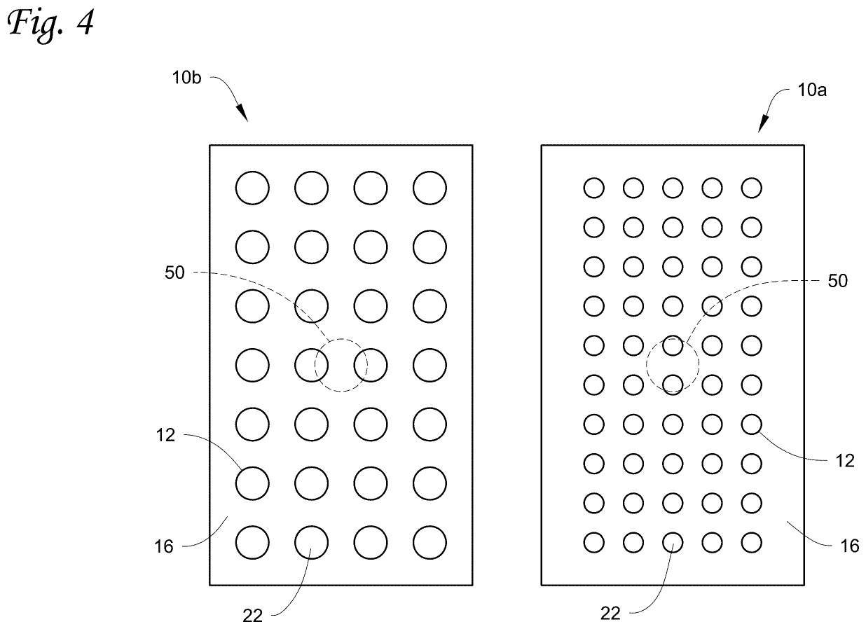

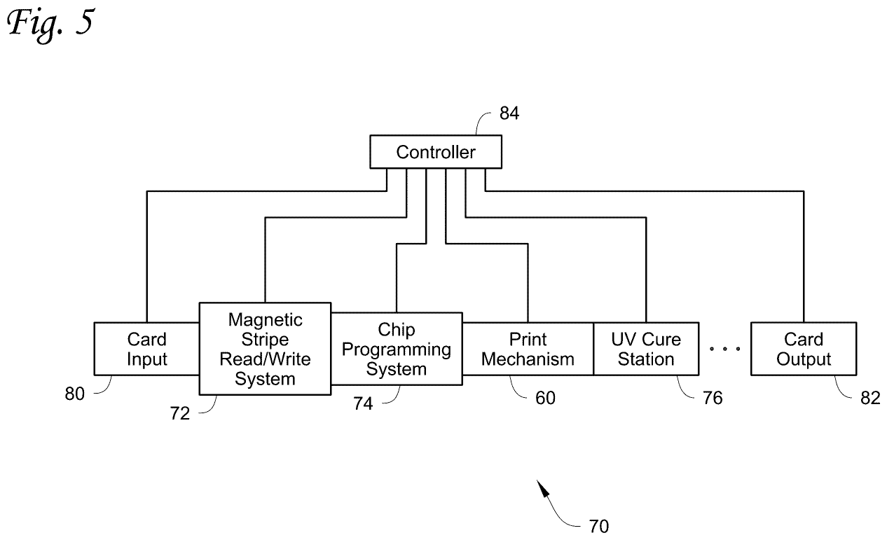

Referring to FIG. 1, a portion of a DOD print head 10 is illustrated as including two or more nozzles 12. In actual practice, as would be understood by a person of ordinary skill in the art, the DOD print head 10 would include a larger number of the nozzles 12. The DOD print head 10 is part of a print mechanism of a card personalization system (each of which is depicted in FIG. 5). The DOD print head 10 may be used by itself or used together with other DOD print heads, for example as depicted in FIGS. 3 and 4. The other DOD print heads may also be controlled to operate like the DOD print head 10 in FIG. 1.

Under normal operating conditions of the DOD print head 10 (for example during a print job), a vacuum is selectively applied to each nozzle 12 which establishes an upwards meniscus 14 (indicated by dashed lines in FIG. 1) of the ink and hence a clean nozzle plate 16 is provided. The nozzle plate 16 is considered clean when there is no ink on the surface of the nozzle plate 16 or ink below the level of the openings of the nozzles 12 that could be applied to a card surface. Each DOD print head 10 can be a piezo-electric DOD print head which requires electrical energy to energize the nozzles 12 of the DOD print head 10 and dispense ink from the energized nozzles 12 through the nozzle plate 16 during a print job on the card. The general mechanical construction and operation of piezo-electric DOD print heads is well-known in the art.

Each DOD print head 10 can be automatically controlled to conduct a maintenance routine on the DOD print head 10. This maintenance routine will be referred to as a spitting routine. In the spitting routine, one or more of the nozzles 12 is electrically actuated a plurality of times in rapid succession. In the spitting routine described herein, the data to perform the multiple firings or actuations of the nozzle(s) is sent to the print head in a single nozzle actuation data signal. In other words, a single nozzle actuation data signal with multiple firing commands can be sent in the spitting routine, as opposed to separate nozzle actuation data signals each with a single firing command in the conventional spitting routine. The single nozzle actuation data signal with multiple firing commands causes the nozzle(s) to be electrically actuated a plurality of times in rapid succession, each actuation causing the emission of a small drop of ink. Each nozzle is actuated as fast as is sustainably possible. Having the actuations as close as possible in time allows the individual waste ink drops to join together into one or more larger waste ink drops. Each one of the larger ink drop has a size that exceeds a waste ink drop size that would result from a single electrical actuation of the nozzle. The larger ink drop(s) has less tendency to aerosolize which reduces aerosol contamination of the nozzle plate and the nozzle.

For example, in an embodiment of the spitting routine described herein, the nozzle(s) may be actuated at least two times in rapid succession. In this embodiment, for two actuations, the nozzle actuation data signal dictating two nozzle actuations would be sent to the print head, then the first nozzle actuation would occur. This first nozzle actuation may take, for example, about 9 microseconds followed by an up to, for example, 6 microsecond resting period, and about 15 microseconds after the first nozzle actuation started, the second nozzle actuation would begin. Once complete, the system would wait a period of time, for example 100 microseconds, to start a next set of actuations if additional actuations are desired. In another embodiment, the nozzle(s) may be actuated seven times in rapid succession. In this embodiment, the data dictating the seven nozzle actuations would be sent to the print head in a single nozzle actuation data signal, then the first nozzle actuation would occur. Assuming that this first nozzle actuation takes about 9 microseconds followed by an up to about 6 microsecond resting period as described above, 15 microsecond after the first nozzle actuation started, the second nozzle actuation would begin. This would continue until all seven nozzle actuations were completed. The nozzle actuation data signal can include any number of nozzle actuation commands greater than two.

In the spitting routine described herein, each actuation causes the nozzle 12 to emit a small drop of ink. By actuating the nozzle 12 in rapid succession a plurality of times, the emitted small drops of ink are close together. The small drops of ink join together or coalesce in flight after being ejected to create one or more larger waste ink drops. For example, FIG. 1 illustrates one of the nozzles 12 (for example the left nozzle 12 in FIG. 1) emitting two small drops 18 of waste ink resulting from two actuations of the nozzle 12 in rapid succession, with the two drops 18 ultimately joining together or coalescing to form, for example, a single larger drop 20 of waste ink. Similarly, the other nozzle 12 in FIG. 1 (for example the right nozzle) is depicted as emitting three small drops 18 of waste ink resulting from three actuations of the nozzle 12 in rapid succession, with the three drops 18 ultimately joining together or coalescing to form, for example, one or more larger drops 20 of waste ink. In other embodiments, the nozzle 12 can be actuated in rapid succession four, five, six, seven or more times during the spitting routine to emit four, five, six, seven or more small drops of waste ink respectively. Each resulting larger waste ink drop 20 has a size that exceeds a waste ink drop size that would result from a single electrical actuation of the nozzle 12. The larger ink drop(s) has less tendency to aerosolize which reduces aerosol contamination of the nozzle plate 16 and the nozzle 12.

FIG. 4 illustrates two side-by-side DOD print heads 10a, 10b. The nozzles 12 of the DOD print head 10a are depicted as having nozzle openings 22 in the nozzle plate 16. Similarly, the nozzles 12 of the DOD print head 10b are depicted as having nozzle openings 22 in the nozzle plate 16. The nozzle openings 22 of the DOD print head 10b are larger than the nozzle openings 22 of the DOD print head 10a. For example, in one embodiment, the nozzle openings 22 of the DOD print head 10a can be sized so as to each emit about 3.5 picoliters in the spitting routine described herein, and the nozzle openings 22 in the DOD print head 10b can be sized so as to each emit about 30 picoliters in the spitting routine described herein. However, the nozzles 12 can have other sizes.

The smaller nozzle openings 22 of the DOD print head 10a are suitable for inks such as cyan (C), magenta (M), yellow (Y) and black (K) inks. The larger nozzle openings 22 of the DOD print head 10b are suitable for inks such as white ink or for varnish. The inks and varnish can be any suitable inks and varnish used in DOD printing and that are suitable for use on the types of cards described herein. For example, the ink and varnish can be radiation curable, for example by UV radiation.

In general, larger nozzle openings like in the DOD print head 10b tend not to experience the aerosolization of a waste ink drop during a conventional spitting routine described herein. Therefore, in an embodiment, the spitting routine described herein may be used on the DOD print head 10a, which may experience aerosolization of the waste ink drop if the conventional spitting routine is used, but not used on the DOD print head 10b which is less likely to experience aerosolization of the waste ink drop. In another embodiment, the spitting routine described herein may be used on each of the DOD print heads 10a, 10b.

The spitting routine described herein also allows a reduction in the amount of nozzle purging that occurs, which reduces the amount of waste ink that is created. Purging is another maintenance routine that can be performed on the DOD print head in addition to the spitting routine. Purging refers to a process where the nozzle 12 is not electrically energized but the vacuum pressure holding the ink in the nozzle 12 is reversed to push ink out of the nozzle 12 using a positive pressure. Upon recovery from a purge routine, the vacuum is restored and all ink in contact with the nozzle 12 and on the nozzle plate 16 adjacent to the nozzles 12 gets sucked back into the nozzles 12 through the nozzle openings to restore the meniscus 14 in each nozzle 12.

Purging typically creates a larger amount of waste ink compared to spitting. However, by implementing the spitting routine described herein, a frequency of purging that is implemented can be reduced compared to a nozzle that is maintained using the conventional spitting routine. For example, referring to FIG. 4, due to implementing the spitting routine described herein, the nozzles 12 of the print head 10a may be purged with a frequency that is less than a frequency of purging of the nozzles 12 of the print head 10b. In one non-limiting example, the nozzles 12 of the print head 10a may be purged once a day, while the nozzles 12 of the print head 10b may be purged twice a day.

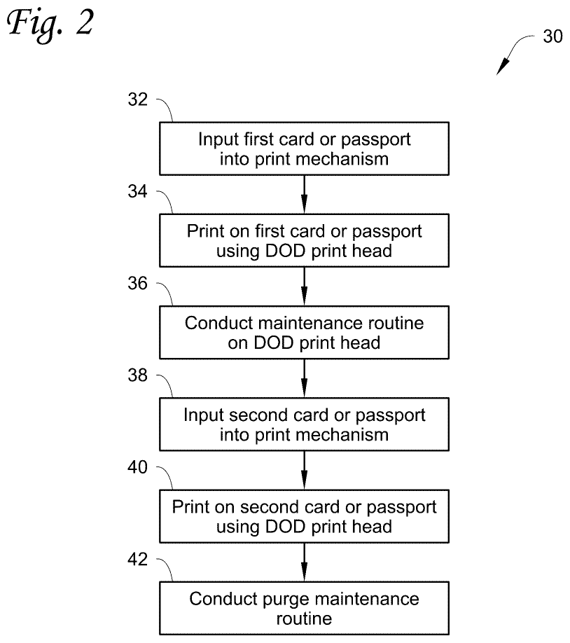

FIG. 2 depicts an example of a method 30 described herein. The method 30 may be referred to as a method of maintaining a drop-on-demand print head in a print mechanism of a card personalization system. Alternatively, the method 30 may be referred to as a method of operating a print mechanism of the card personalization system, or referred to as a method of printing on cards using the print mechanism.

In the method 30, a first card is input into the print mechanism in step 32. The first card may be transported into the print mechanism directly from a card input whereby the print mechanism is the first processing mechanism in which the first card is processed, or the first card may be input from the card input and processed in another processing mechanism, for example a chip programmer and/or a magnetic strip encoder, before being transported into the print mechanism. The first card (and other cards in the system) can be transported using any suitable mechanical card transport mechanism(s) that are well known in the art.

At step 34, the first card is printed on using one or more DOD print heads in the print mechanism. The printing that occurs on the first card can be one or more of printing an image of the intended cardholder, printing the cardholder's name, printing an account number, printing non-card holder graphics on the card, and other printing. The printing can be monochromatic or multi-color, and in an embodiment can include printing of a varnish or other non-ink material from a DOD print head onto the first card. After printing, if the printed ink or varnish is radiation curable, the card may be transported to a suitable location in the system where radiation, such as UV radiation, is applied to cure the printed ink or varnish.

At step 36, the maintenance routine (i.e. the spitting routine described herein) is performed on the one or more DOD print heads. In an embodiment, the maintenance routine in step 36 can be performed after the printing of the first card in step 34 (i.e. no other cards are printed between printing on the first card and start of the maintenance routine). In another embodiment, the maintenance routine in step 36 can be performed after a number of additional cards are printed after printing of the first card in step 34. The maintenance routine in step 36 can be initiated automatically, for example at a predetermined time, or be user initiated. The maintenance routine in step 36 may be performed relatively shortly (for example seconds or a few minutes) after the first card or another card is printed, or the maintenance routine may be performed a relatively long time (for example hours) after the first card or another card is printed. For example, the first card or another card could be printed the day before, and the maintenance routine of step 36 is conducted the next day before starting printing on any new cards. Alternatively, the maintenance routine of step 36 may be conducted after the last card of a batch print job is completed and before the next batch print job is performed. The maintenance routine may be performed while the print mechanism is in a grey-scale mode. The use of grey-scale mode in a print mechanism is known in the art.

Sometime after the maintenance routine of step 36 is completed, in step 38 a second card is input into the print mechanism. The second card may be transported into the print mechanism directly from a card input whereby the print mechanism is the first processing mechanism in which the second card is processed, or the second card may be input from the card input and processed in another processing mechanism, for example a chip programmer and/or a magnetic strip encoder, before being transported into the print mechanism. The second card (and other cards in the system) can be transported using any suitable mechanical card transport mechanism(s) that are well known in the art. In an embodiment, step 38 can occur a relatively short time (for example seconds or minutes) after the maintenance routine of step 36. For example, step 38 can occur at the beginning of a day when starting a print job, or the step 38 can be the start of a new batch print job after completion of a prior print job and after completion of step 36.

At step 40, the second card is printed on using the one or more DOD print heads. The printing that occurs on the second card can be one or more of printing an image of the intended cardholder, printing the cardholder's name, printing an account number, printing non-card holder graphics on the card, and other printing. The printing can be monochromatic or multi-color, and in an embodiment can include printing of a varnish or other non-ink material from a DOD print head onto the second card. After printing, if the printed ink or varnish is radiation curable, the second card may be transported to a suitable location in the system where radiation, such as UV radiation, is applied to cure the printed ink or varnish.

After printing on the second card is completed, an optional step 42 can be performed. Step 42, if performed, is to conduct a purge maintenance routine on the one or more DOD print heads. The purge maintenance routine can be conducted in the manner discussed above. The purge maintenance routine can be initiated automatically, for example at a predetermined time, or be user initiated. The purge maintenance routine can be conducted at the end of a day after print jobs have been completed and/or at the beginning of a day prior to beginning new print jobs for the day. Alternatively, the purge maintenance routine can be conducted after the last card of a batch print job is completed and before the next batch print job is performed.

Referring again to FIG. 4, during the maintenance routine (i.e. the spitting routine), the nozzles 12 that are electrically actuated to eject waste ink drops can be selected by the controller than controls operation of the DOD print head. For example, a first set of the nozzles 12 of the DOD print head 10a, 10b can be electrically actuated in the spitting routine to trigger an ejection of waste ink from each electrically actuated nozzle of the first set, and a second set of the nozzles 12 of the DOD print head 10a, 10b is not electrically actuated during the spitting routine. For example, in one embodiment, the first set of the nozzles can be the nozzles 12 that are at the perimeter of the nozzle plate 16, while the second set of the nozzles 12 are those nozzles surrounded by the perimeter nozzles 12. In this example, with the DOD print head 10a, 10b including an ink inlet 50 (indicated in broken lines), the spitting routine can be implemented on the subset of the nozzles 12 which are further away from the ink inlet 50 of the DOD head with more ejections of waste ink, as those are the nozzles 12 that tend to exhibit performance deterioration from blockage, etc. the most.

FIG. 3 illustrates select components of a print mechanism 60 of a card personalization system that can utilize the DOD print head(s) 10 described herein. The print mechanism 60 includes at least one of the DOD print heads 10. In this example, four of the DOD print heads 10a (FIG. 4) are illustrated for printing CMYK ink, and one print head 10b (FIG. 4) for printing white ink. Optionally, a sixth DOD print head 10b can be provided next to the white print head for printing a varnish. The printing performed by the print mechanism 60 can be monochromatic or multi-color. FIG. 3 shows the DOD print heads arranged side-by-side to sequentially print onto a surface of a card 62 as the card 62 is transported past the DOD print heads, for example underneath the DOD print heads, in the direction of the arrow 64. However, a smaller number of the DOD print heads, including one of the DOD print heads, or a larger number of the DOD print heads, can be used. The DOD print heads can print using any suitable ink or coating used in DOD printing and that is suitable for use on the types of cards described herein. For example, the ink can be a UV radiation curable ink, a heat curable ink that can be cured by applying heat to the heat curable ink, or other ink or materials that can be deposited by DOD print heads.

Optionally, an automated covering cap 66 can be provided that is configured to be movable in the direction of the arrow 68 between a covering position over the DOD print head(s) and a non-covering position. The cap 66 is selectively movable from the non-covering position to the covering position below the print heads under control of a controller. The cap 66 has multiple functions. One function is to provide a location to spit and purge waste ink during the spitting routine and the purge routine. Further information on the covering cap 66 is disclosed in U.S. Pat. No. 11,072,169 which is incorporated herein by reference in its entirety.

FIG. 5 illustrates an example of a card personalization system 70 in which the concepts described herein can be implemented. The system 70 is configured to personalize cards by at least printing on the cards using the print mechanism 60. The system 70 can also include at least one other card processing capability in addition to the printing by the print mechanism 60. For example, the additional card processing can include a magnetic strip read/write system 72 that is configured to read data from and/or encode data on a magnetic strip on the cards, and/or an integrated circuit chip programming system 74 that is configured to program an integrated circuit chip on the cards. When the print mechanism 60 prints using ultraviolet (UV) radiation curable ink, a UV cure station 76 can also be provided. The construction and operation of the systems 72, 74, 76 is well known in the art. Magnetic strip read/write systems and integrated circuit chip programming systems are disclosed, for example, in U.S. Pat. Nos. 6,902,107 and 6,695,205, and can be found in the MX™ and MPR™ family of central issuance systems available from Entrust Corporation of Shakopee, Minnesota. An example of a UV cure station is the UV cure station used in the MX™ family of card issuance systems available from Entrust Corporation of Shakopee, Minnesota.

In the system 70 illustrated in FIG. 5, a card input 80 is provided that is configured to hold a plurality of cards waiting to be processed. Cards are fed one-by-one from the card input 80 into the rest of the system 70 where each card is individually processed. Processed cards are transported into a card output 82 that is configured to hold a plurality of the processed cards.

Operation of the various systems 60, 72, 74, 76, 80, 82 is controlled by one or more controllers 84. Alternatively, each one of the systems 60, 72, 74, 76, 80, 82, or select ones of the systems 60, 72, 74, 76, 80, 82, can have its own dedicated controller.

The cards can be transported through the card personalization system 70 using any suitable mechanical card transport mechanism(s) that are well known in the art. Examples of card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art. A person of ordinary skill in the art would readily understand the type(s) of card transport mechanisms that could be used, as well as the construction and operation of such card transport mechanisms.

The system 70 may include additional card personalization systems not illustrated in FIG. 5, which are well known in the art of card processing. For example, the system 70 may include a card embossing system that is configured to emboss characters on the cards; an indenting system that is configured to indent characters on the cards; a laminator system that is configured to apply a laminate to the cards; a laser system that uses a laser to perform laser processing such as laser marking on the cards; a topcoat station that is configured to apply a topcoat to a portion of or the entire surface of the cards; a quality control station that is configured to check the quality of personalization/processing applied to the cards; a security station that is configured to apply a security feature such as a holographic foil patch to the cards; and other card processing operations. The additional card personalization systems may be located anywhere in the system 70.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of maintaining a first drop-on-demand print head in a print mechanism of a card or passport personalization system, comprising:
printing on a first card or passport in the print mechanism using the first drop-on-demand print head;
after the printing on the first card or passport, conducting a maintenance routine on the first drop-on-demand print head, the maintenance routine includes sending a nozzle actuation data signal to the drop-on-demand print head, the nozzle actuation data signal includes two or more nozzle firing commands each of which electrically actuates one or more nozzles of the first drop-on-demand print head;
after the maintenance routine, printing on a second card or passport in the print mechanism using the first drop-on-demand print head.

2. The method of claim 1, comprising conducting the maintenance routine while the print mechanism is in a grey-scale mode.

3. The method of claim 1, wherein the one or more nozzles of the first drop-on-demand print head have a first nozzle size; and
the print mechanism comprises a second drop-on-demand print head having one or more nozzles that have a second nozzle size that is greater than the first nozzle size.

4. The method of claim 3, wherein the first drop-on-demand print head prints cyan, magenta, yellow or black ink; and the second drop-on-demand print head prints white ink or varnish.

5. The method of claim 3, comprising conducting a first purge maintenance routine at a first frequency on the one or more nozzles of the first drop-on-demand print head, and conducting a second purge maintenance routine at a second frequency on the one or more nozzles of the second drop-on-demand print head; wherein the second frequency is greater than the first frequency.

6. The method of claim 1, further comprising conducting a purge maintenance routine on the one or more nozzles of the first drop-on-demand print head, wherein the purge maintenance routine occurs after the printing on the second card or passport in the print mechanism.

7. The method of claim 1, wherein during the maintenance routine:
electrically actuating a first set of the nozzles of the first drop-on-demand print head to trigger an ejection of waste ink from each electrically actuated nozzle of the first set, and a second set of the nozzles of the first drop-on-demand print head is not electrically actuated during the maintenance routine.

8. The method of claim 7, wherein the drop-on-demand print head includes an ink inlet, and the nozzles of the first set are further away from the ink inlet than are the nozzles of the second set.

9. A card or passport personalization system, comprising:
an input that is configured to hold a plurality of cards or passports to be processed;
a print mechanism downstream from the input and receiving cards or passports that are input from the input, the print mechanism includes a first drop-on-demand print head, and the first drop-on-demand print head is configured to print with ink;
a controller connected to the print mechanism and that automatically controls the operation thereof, the controller is programmed to control printing on the cards or passports and to automatically perform a maintenance routine on the first drop-on-demand print head that includes generating a nozzle actuation data signal, where the nozzle actuation data signal includes two or more nozzle firing commands each of which is able to electrically actuate one or more nozzles of the first drop-on-demand print head.

10. The card or passport personalization system of claim 9, wherein the controller includes a grey-scale mode, and the controller performs the maintenance routine while in the grey-scale mode.

11. The card or passport personalization system of claim 9, wherein the ink is radiation curable ink; and further comprising a cure station that is configured to cure radiation curable ink applied to the cards or passports by the first drop-on-demand print head.

12. The card or passport personalization system of claim 9, wherein the one or more nozzles of the first drop-on-demand print head have a first nozzle size; and
the print mechanism comprises a second drop-on-demand print head having one or more nozzles that have a second nozzle size that is greater than the first nozzle size.

13. The card or passport personalization system of claim 12, wherein the first drop-on-demand print head is connected to a source of cyan, magenta, yellow or black ink; and the second drop-on-demand print head is connected to a source of white ink or varnish.

14. The card or passport personalization system of claim 12, wherein the controller controls the print mechanism to conduct a first purge maintenance routine at a first frequency on the one or more nozzles of the first drop-on-demand print head, and to conduct a second purge maintenance routine at a second frequency on the one or more nozzles of the second drop-on-demand print head; and wherein the second frequency is greater than the first frequency.

15. The card or passport personalization system of claim 9, wherein the controller controls the print mechanism to conduct a purge maintenance routine on the one or more nozzles of the first drop-on-demand print head, wherein the purge maintenance routine occurs after the maintenance routine.

16. The card or passport personalization system of claim 9, wherein the controller controls the print mechanism so that during the maintenance routine, a first set of nozzles of the first drop-on-demand print head are electrically actuated to trigger an ejection of waste ink from each electrically actuated nozzle of the first set, and a second set of nozzles of the first drop-on-demand print head is not electrically actuated during the maintenance routine.

17. A method of maintaining a drop-on-demand print head in a print mechanism of a card or passport personalization system, the drop-on-demand print head includes a plurality of nozzles, the method comprising:
printing on a first card or passport in the print mechanism using the drop-on-demand print head;
after the printing on the first card or passport, conducting a maintenance routine on the drop-on-demand print head that includes electrically actuating a first set of the plurality of nozzles to trigger an ejection of waste ink from each electrically actuated nozzle of the first set, and a second set of the plurality of nozzles is not electrically actuated during the maintenance routine;
after the maintenance routine, printing on a second card or passport in the print mechanism using the drop-on-demand print head.

18. The method of claim 17, wherein the drop-on-demand print head includes an ink inlet, and the nozzles of the first set are further away from the ink inlet than are the nozzles of the second set.

19. A method of maintaining a first drop-on-demand print head in a print mechanism of a card or passport personalization system, comprising:
printing on a first card or passport in the print mechanism using the first drop-on-demand print head;
after the printing on the first card or passport, conducting a maintenance routine on the first drop-on-demand print head that includes electrically actuating one or more nozzles of the first drop-on-demand print head at least two times in succession triggering at least two ejections of waste ink that join in flight to create one or more waste ink drops each having a size that exceeds a waste ink drop size that would result from a single electrical actuation of the one or more nozzles of the first drop-on-demand print head;
after the maintenance routine, printing on a second card or passport in the print mechanism using the first drop-on-demand print head.
